(19) United States
(12) Patent Application Publication
(10) Pub. No.: US 2012/0223227 A1
(43) Pub. Date: Sep. 6, 2012

(54) APPARATUS AND METHODS FOR REAL-TIME THREE-DIMENSIONAL SEM IMAGING AND VIEWING OF SEMICONDUCTOR WAFERS

(76) Inventors: Chien-Huei CHEN, San Jose, CA (US); Paul D. MacDONALD, Tracy, CA (US); Rajasekhar KUPPA, Santa Clara, CA (US); Takuji TADA, San Jose, CA (US); Gordon ABBOTT, Pleasanton, CA (US); Cho TEH, Los Altos, CA (US); Hedong YANG, Santa Clara, CA (US); Stephen LANG, Hollis, NH (US); Mark A. NEIL, San Jose, CA (US); Zain SAIDIN, San Mateo, CA (US)

(21) Appl. No.: 13/041,017

(22) Filed: Mar. 4, 2011

(51) Int. Cl. G01N 23/04

(52) U.S. Cl. 250/307; 250/310

(57) ABSTRACT

One embodiment relates to a method of real-time three-dimensional electron beam imaging of a substrate surface. A primary electron beam is scanned over the substrate surface causing electrons to be emitted therefrom. The emitted electrons are simultaneously detection using a plurality of at least two off-axis sensors so as to generate a plurality of image data frames, each image data frame being due to electrons emitted from the substrate surface at a different view angle. The plurality of image data frames are automatically processed to generate a three-dimensional representation of the substrate surface. Multiple views of the three-dimensional representation are then displayed. Other embodiments, aspects and features are also disclosed.

### BACKGROUND OF THE INVENTION

1. Field of the Invention

The present invention relates to methods and apparatus for electron beam imaging and for processing electron beam image data.

2. Description of the Background Art

The scanning electron microscope (SEM) is a type of electron microscope. In an SEM, the specimen is scanned with a focused beam of electrons which produce secondary and/or backscattered electrons (SE and/or BSE) as the beam hits the specimen. These are detected and typically converted into an image of the surface of the specimen. The image is typically from a “normal” view (i.e. a view from a perspective perpendicular to the semiconductor surface).

However, in recent years, the structure and morphology of critical structures and defects in integrated circuits has become increasingly important. The advent of device structures that are constructed vertically above the semiconductor surface may need to be visualized in order to understand how the process is performing. Critical defects within the semiconductor device are increasingly more subtle, from an absolute perspective, and require additional contextual information to affect root cause analysis.

### SUMMARY

One embodiment relates to a method of real-time three-dimensional electron beam imaging of a substrate surface. A primary electron beam is scanned over the substrate surface causing electrons to be emitted therefrom. The emitted electrons are simultaneously detection using a plurality of at least two off-axis sensors so as to generate a plurality of image data frames, each image data frame being due to electrons emitted from the substrate surface at a different view angle. The plurality of image data frames are automatically processed to generate a three-dimensional representation of the substrate surface. Multiple views of the three-dimensional representation are then displayed.

Another embodiment relates to an apparatus configured for real-time three-dimensional electron beam imaging of a substrate surface. The apparatus includes at least a source for generating a primary electron beam, scan deflectors, a detection system, and an image data processing system. The scan detectors are configured to deflect the primary electron beam so as to scan the primary electron beam over the substrate surface causing electrons to be emitted from the substrate surface. The detection system is configured for the simultaneous detection of emitted electrons using a plurality of at least two off-axis sensors so as to generate a plurality of image data frames. Each image data frame is due to electrons emitted from the substrate surface at a different view angle. The image data processing system is configured to automatically process the plurality of image data frames to generate multiple views of a three-dimensional representation of the substrate surface.

Other embodiments, aspects and features are also disclosed.

### BRIEF DESCRIPTION OF THE DRAWINGS

FIG. 1 is a flow chart of a method of real-time three-dimensional SEM imaging and viewing of semiconductor wafers in accordance with an embodiment of the invention.

FIG. 2 is a schematic diagram of a first embodiment of an electron beam apparatus configured to simultaneously collect the image data from three or more view angles.

FIG. 3 is a schematic diagram of a detector segmentation in accordance with an embodiment of the invention.

FIGS. 4A and 4B illustrate a second embodiment of an electron beam apparatus configured to simultaneously collect the image data from three or more view angles.

FIGS. 5A and 5B illustrate a third embodiment of an electron beam apparatus configured to simultaneously collect the image data from three or more view angles.

FIG. 6 depicts an example of left-eye and right-eye stereoscopic views of a region of interest.

FIGS. 7A, 7B, 7C and 7D provide example captured frames from a video where the view in the video moves along a view path showing the region of interest.

### DETAILED DESCRIPTION

Scanning electron microscope (SEM) imaging and viewing of critical locations of semiconductor wafers are commonly taken from a “normal” view. However, from such a normal view, it is difficult to perceive topological information of the sample surface.

Previous techniques for obtaining SEM images with non-normal angular perspectives typically involve manually tilting of either the SEM column or the sample to change the angle of the incident beam relative to the sample surface. Another previous technique involves sequentially acquiring two images at two different non-normal angular view points. After the acquisition of the second image, a user may then utilize a stereoscopic viewing device to perceive a three-dimensional image of the sample surface.

However, these previous techniques require mechanical movement (of either the column or sample stage) and the sequential acquisition of two images. These requirements adversely impact the throughput of an e-beam inspection tool. Moreover, the viewing perspective is limited based on the tilt angle(s) used during image acquisition.

The apparatus and methods disclosed herein provide real-time three-dimensional topology and context information about critical structures and defects during a semiconductor manufacturing process. This enables single-pass visualization and more complete characterization of defects in high-k dielectric metal gate transistors and other three-dimensional structures. Using the techniques disclosed herein, an order of magnitude savings may be achieved in the time required to obtain three-dimensional imaging of large quantities of critical regions of interest of semiconductor samples. Precise position and imaging collection of a critical area is provided, allowing a more complete understanding of the structure of interest in the context of the background pattern and the constituent materials, thus achieving better absolute sensitivity.

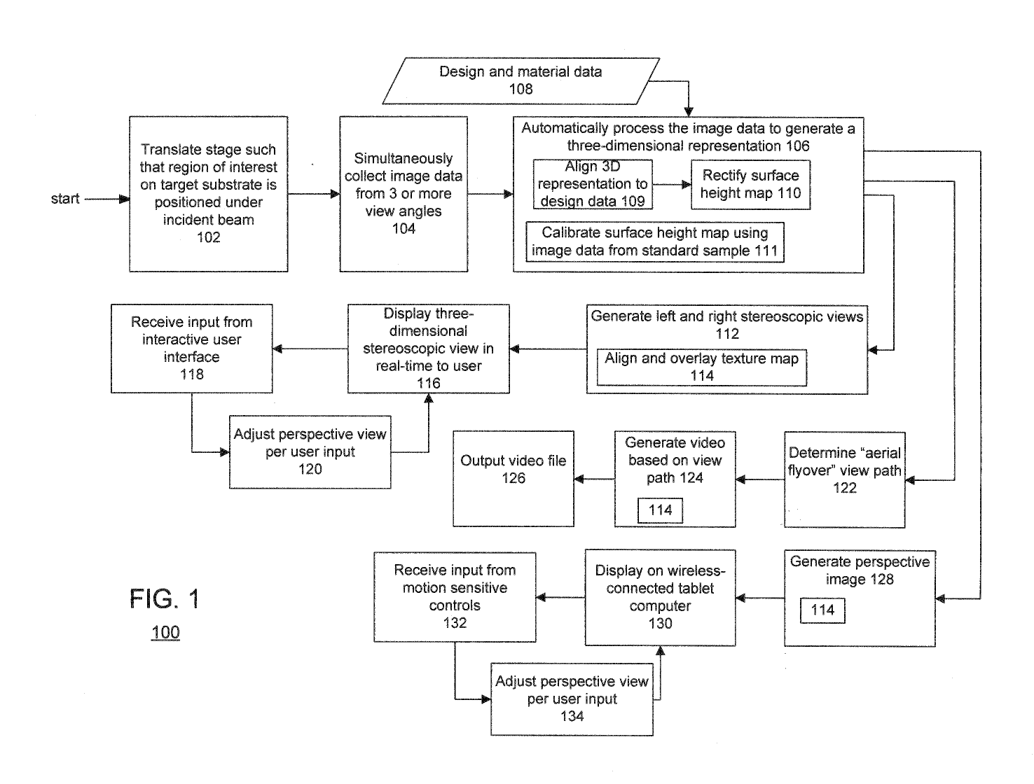

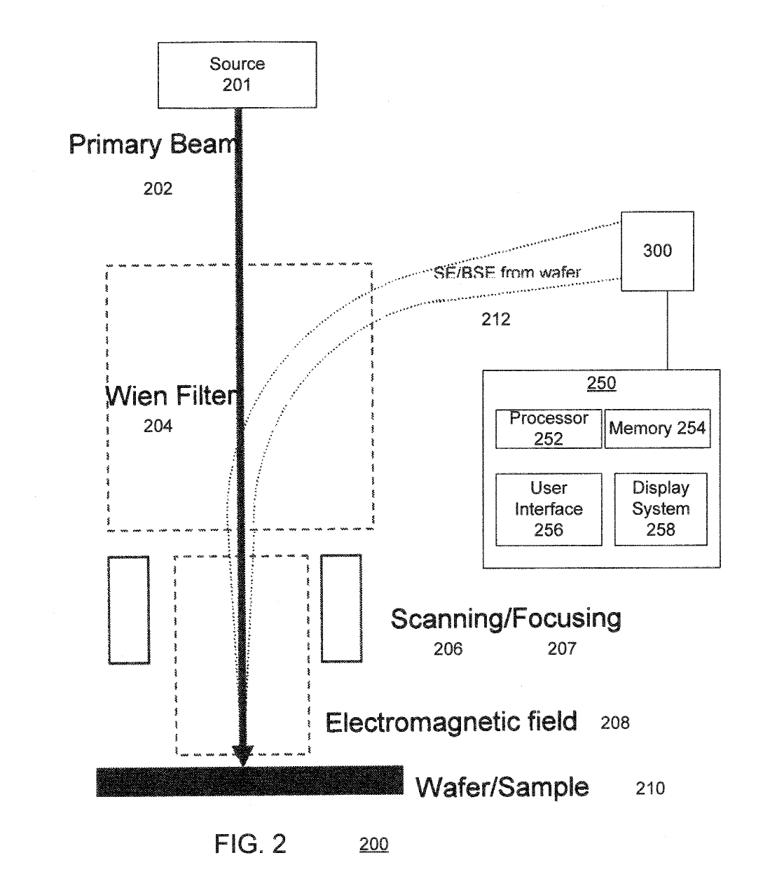

FIG. 1 is a flow chart of a method 100 of real-time three-dimensional SEM imaging and viewing of semiconductor wafers in accordance with an embodiment of the invention. As shown, the method 100 may begin by translating 102 a stage holding a target substrate such that a region of interest on the target substrate is positioned under an incident beam of the SEM column. Thereafter, while the region of interest is scanned by the incident beam, image data is simultaneously collected 104 from three or more view angles. Embodiments of apparatus configured to simultaneously collect the image data from three or more view angles are described below in relation to FIGS. 2, 3, 4A, 4B, 5A and 5B.

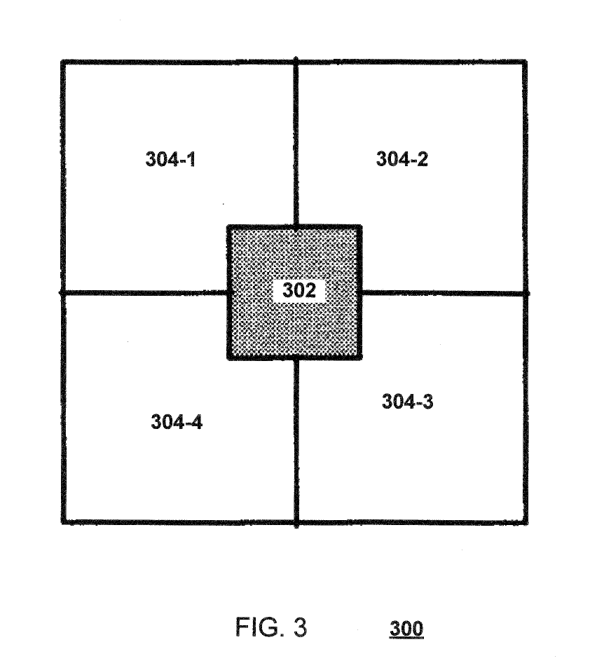

Referring to FIGS. 2 and 3, these figures show a first embodiment of an apparatus configured to simultaneously collect the image data from three or more view angles. FIG. 2 provides a cross-sectional diagram of the electron beam column, and FIG. 3 provides a planar view of a segmented detector that may be used with the column.

As shown in FIG. 2, a source 201 generates a primary beam (i.e. an incident beam) 202 of electrons. The primary beam 202 passes through a Wien filter 204. The Wien filter 204 is an optical element configured to generate electrical and magnetic fields which cross each other. Scanning deflectors 206 and focusing electron lenses 207 are utilized. The scanning deflectors 206 are utilized to scan the electron beam across the surface of the wafer or other substrate sample 210. The focusing electron lenses 207 are utilized to focus the primary beam 202 into a beam spot on the surface of the wafer or other substrate sample 210. In accordance with one embodiment, the focusing lenses 207 may operate by generating electric and/or magnetic fields.

As a result of the scanning of the primary beam 202, electrons are emitted or scattered from the sample surface. These emitted electrons may include secondary electrons (SE) and/or backscattered electrons (BSE). The emitted electrons are then extracted from the wafer or other sample (wafer/sample) 210. These emitted electrons are exposed to the action of the final (objective) lens by way of the electromagnetic field 208. The electromagnetic field 208 acts to confine the emitted electrons to within a relatively small distance from the primary beam optic axis and to accelerate these electrons up into the column. In this way, a scattered electron beam 212 is formed from the emitted electrons. The Wien filter 204 deflects the scattered electron beam 212 from the optic axis of the primary beam 202 to a detection axis (the optic axis for the detection system of the apparatus). This serves to separate the scattered electron beam 212 from the primary beam 202.

In accordance with one embodiment of the invention, the detection system may include, for example, a segmented detector 300, which is shown in further detail in FIG. 3, and an image processing system 250. The image processing system 250 may include a processor 252, data storage (including memory) 254, a user interface 256 and a display system 258. The data storage 254 may be configured to store instructions and data, and the processor 252 may be configured to execute the instructions and process the data. The display system 258 may be configured to display views of the substrate surface to a user. The user interface 256 may be configured to receive user inputs, such as, for example, to change a view angle being displayed.

As shown in FIG. 3, the segmented detector 300 may include five sensors or detector segments 302, 304-1, 304-2, 304-3, and 304-4. The center (on-axis) segment 302 may be configured to detect image data from a center of the scattered electron beam 212. The center segment 302 is on-axis in that it lies on the detection axis. The image data from the center segment 302 may correspond to image data from a normal view (i.e. a view angle which is normal to the sample surface at a polar angle of zero degrees). The four outer (off-axis) segments (304-1, 304-2, 304-3, and 304-4) may correspond to image data from angular views (i.e. view angles which are non-normal to the sample surface at a non-zero polar angle and at different azimuthal angles). In other words, each of the four outer segments (304-1, 304-2, 304-3, and 304-4) detect scattered electrons emitted from the substrate surface at a different azimuthal angle (for example, spaced approximately 90 degrees apart), but at the same, or approximately the same, polar angle. The outer segments (304-1, 304-2, 304-3, and 304-4) are off-axis in that they lie off the detection axis. In alternative implementations, different segmentations may be implemented.

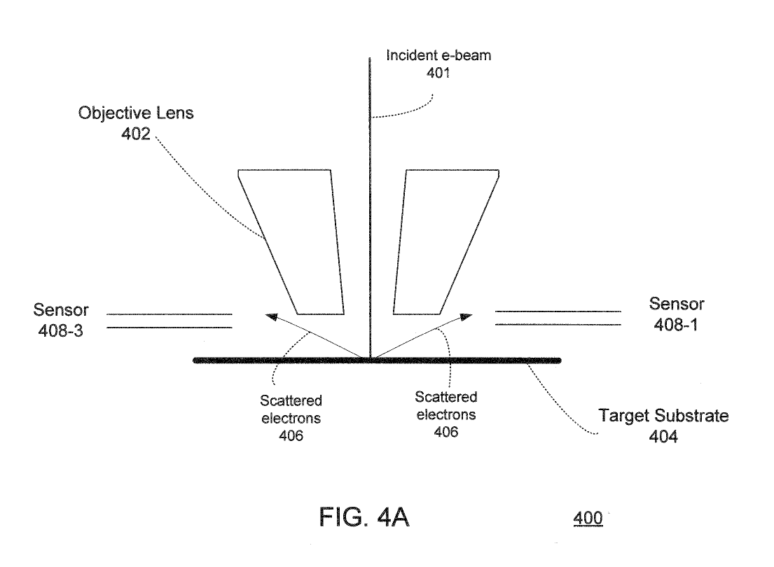

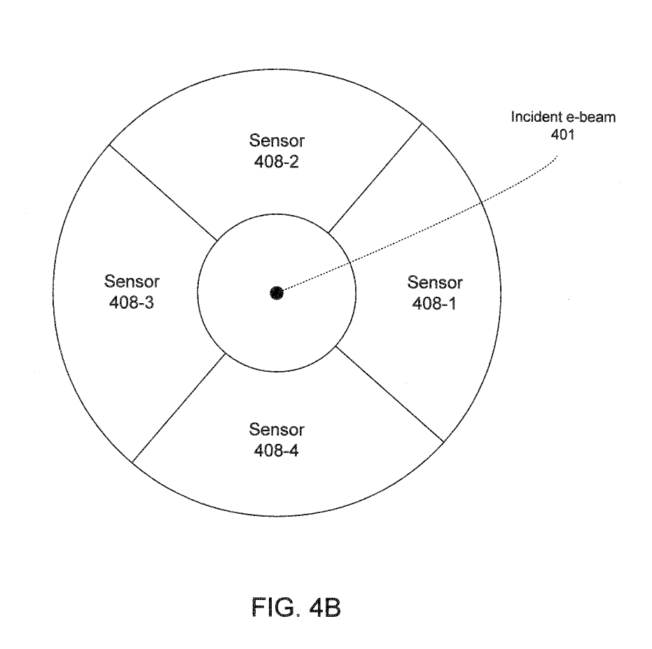

Referring to FIGS. 4A and 4B, these figures illustrate a second embodiment of an apparatus configured to simultaneously collect the image data from three or more view angles. FIG. 4A provides a cross-sectional view of the bottom portion of an electron beam column 400, and FIG. 4B provides a planar view of a segmented detector that may be used with the column.

As depicted in FIG. 4A, the objective lens 402 is configured to focus the incident e-beam 401 onto the surface of the target substrate 404. The incident e-beam 401 may be generated by an electron gun and scanned by deflectors in a similar manner as described above in relation to the e-beam column shown in FIG. 2. In this embodiment, multiple detector segments (or multiple separate detectors) are configured in a below-the-lens configuration.

In this below-the-lens configuration 400, the off-axis or “side” sensors or detector segments (408-1, 408-2, 408-3, and 408-4) are positioned below the objective lens 402 at the bottom of the electron beam column (near the target substrate). Under certain conditions, electrons emitted at higher polar angles (preferably 45 degrees or more) relative to the surface normal (i.e. emitted with trajectories closer to the surface) will preferentially reach such below-the-lens detectors. The detectors may be separated or joined together to form a segmented detector. As these electrons are typically more sensitive to surface topology, images formed with such detectors show the topography of the surface with an azimuthal perspective defined by the detector positioning with respect to the primary beam optic axis and the sample/wafer plane.

In the cross-sectional diagram of FIG. 4A, two off-axis detector segments 408-1 and 408-3 are depicted. The planar view given in FIG. 4B shows four off-axis detector segments (408-1, 408-2, 408-3, and 408-4) surrounding the electron-optical axis of the column (along which travels the incident e-beam 401). In this implementation, each detector segment may detect scattered electrons 406 emitted from the target surface within a range of azimuthal angles spanning approximately 90 degrees. Hence, each detector segment provides a different view angle (spaced approximately 90 degrees apart in azimuthal angle and at a same polar angle).

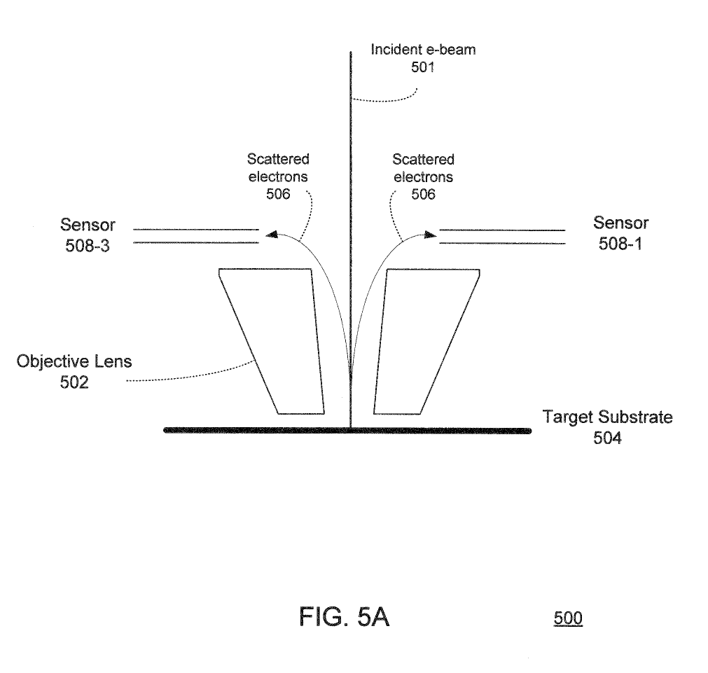

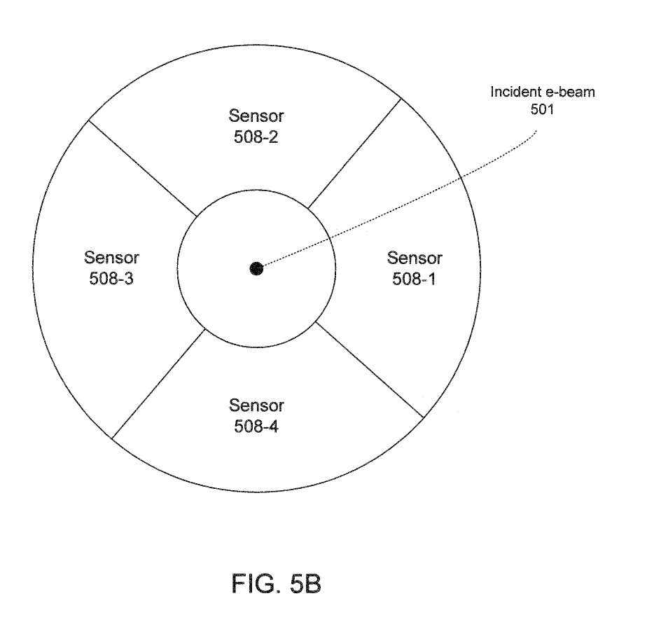

Referring to FIGS. 5A and 5B, these figures illustrate a third embodiment of an apparatus configured to simultaneously collect the image data from three or more view angles. FIG. 5A provides a cross-sectional view of the bottom portion of an electron beam column 500, and FIG. 5B provides a planar view of a segmented detector that may be used with the column.

As depicted in FIG. 5A, the objective lens 502 is configured to focus the incident e-beam 501 onto the surface of the target substrate 504. The incident e-beam 501 may be generated by an electron gun and scanned by deflectors in a similar manner as described above in relation to the e-beam column shown in FIG. 2. In this embodiment, multiple detector segments (or multiple separate detectors) are configured in a behind-the-lens configuration.

In this behind-the-lens configuration 500, the off-axis or “side” sensors or detector segments (508-1, 508-2, 508-3, and 508-4) are on the opposite side of the objective lens 502 from the target substrate 504. In other words, the objective lens 502 is between the target substrate 504 and the “side” detectors or detector segments (508-1, 508-2, 508-3, and 508-4). In this case, the magnetic field of the objective lens may be configured to confine the emitted electrons (which may include electrons emitted at polar angles greater than 45 degrees from the surface normal) and direct them towards the behind-the-lens detector array (508-1, 508-2, 508-3, and 508-4). Similarly to the below-the-lens configuration 400, images may be formed using the detected signals from the behind-the-lens configuration 500 that show topographical information about the surface of the target substrate 504.

In the cross-sectional diagram of FIG. 5A, two detector segments 508-1 and 508-3 are shown. The planar view given in FIG. 5B shows four detector segments (508-1, 508-2, 508-3, and 508-4) surrounding the axis of the column (along which travels the incident e-beam 501). In this implementation, each detector segment may detect electrons emitted from the target surface within a range of azimuthal angles spanning approximately 90 degrees. Hence, each detector segment provides a different view angle (spaced approximately 90 degrees apart in azimuthal angle and at a same polar angle).

In both the second embodiment 400 or third embodiment 500 described above, more or fewer detector segments may be used. For example, if three evenly-spaced detector segments are used, then each may provide a view angle effectively spaced 120 degrees apart in azimuthal angle. As another example, if five evenly-spaced detector segments are used, then each may provide a view angle effectively spaced 72 degrees apart in azimuthal angle. As another example, if six evenly-spaced detector segments are used, then each may provide a view angle effectively spaced 60 degrees apart in azimuthal angle. Also, the detector segments or separate detectors may be discrete so as to collect scattered electrons from much smaller ranges of azimuthal angles. Furthermore, in addition to the “side” (non-normal view) detectors, a conventional detector configuration (such as the central detector 302 in FIG. 3) may be included to simultaneously obtain image data from the normal view.

Referring back to FIG. 1, after the electron beam image data is simultaneously collected from three or more viewing angles, the image data is then automatically processed 106 in order to generate a three-dimensional representation of the surface of the region of interest. In one embodiment, the three-dimensional representation may be constructed based on a Lambertian model. Alternatively, the three-dimensional representation may be constructed based on stereo vision.

Design and material data 108 relating to the integrated circuit being fabricated on the semiconductor surface may be accessed during the automatic processing 106. The three-dimensional representation may then be aligned 109 to the design data. Subsequently, a surface height map from the three-dimensional representation may be rectified 110 using the layer information in the design data. Alternatively, the surface height map from the three-dimensional representation may be calibrated 111 using image data from a standard sample, as may be appreciated by one of skill in the pertinent art.

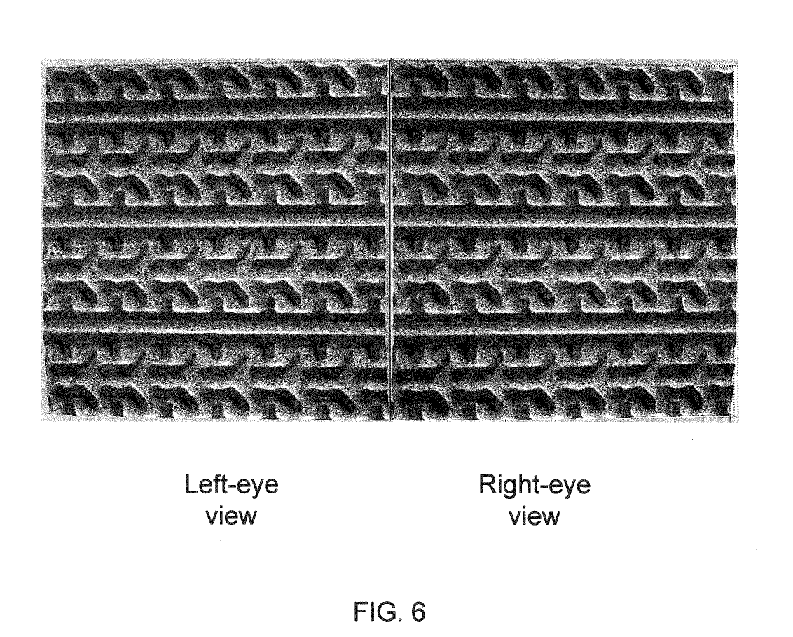

In accordance with one embodiment, images corresponding to left-eye and right-eye stereoscopic views may be generated 112 using the three-dimensional representation. Example of left-eye and right-eye stereoscopic views of a region of interest are shown in FIG. 6. Optionally, a texture map based on the material data may be aligned and overlaid 114 on top of each of the stereoscopic views to show material contrast. Thereafter, a three-dimensional (3D) stereoscopic view may be displayed 116 to the user. The display may be in real time while the target substrate is still under the scanning electron beam. In one implementation, the display may comprise a goggle-style binocular 3D video display for stereoscopic visualization of the textured 3D representation. Interaction with the 3D representation may be provided by way of a user interface device. User input may be received 118 by way of the user interface device, and the perspective of the stereoscopic view may be adjusted 120 based on the user input. For example, tilt, rotation and zoom inputs may be used to change the perspective of the stereoscopic view.

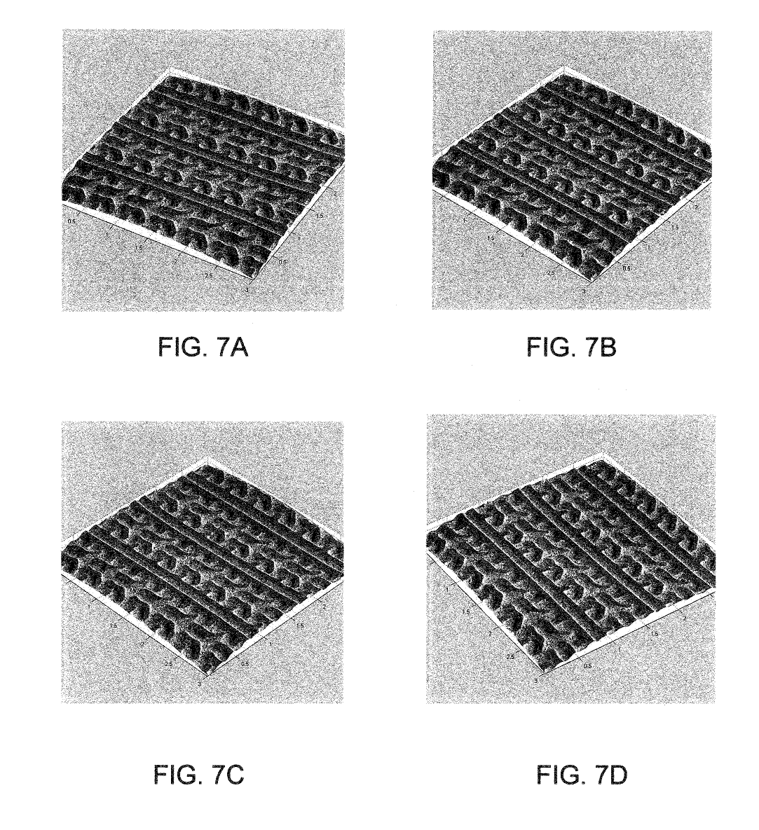

In accordance with another embodiment, an exemplary “aerial flyover” view path may be determined 122. The view path preferably views the region of interest from a range of angles and distances. A video comprising a sequential set of frames is then generated 124 based on the view path. The frames of the video depict perspective views as if a camera was “flying over” the region of interest. In other words, a video of the region of interest is generated 124 as the angle, and/or tilt and/or zoom of the view may be varied smoothly. Optionally, a texture map based on the material data may be aligned and overlaid 114 on top of each frame to show material contrast. Four example video frames captured from a video are provided in FIGS. 7A, 7B, 7C and 7D. Here, the video is of the same region of interest as FIG. 6, and the captured frames are two seconds apart in the video to illustrate the change in view angle during the video. The example video frames are overlayed with a texture map to show material contrast. The video may be then output 126 in a video file format, such as an AVI or similar file format.

In accordance with another embodiment, an image of a perspective view of the three-dimensional representation may be generated 128. Optionally, a texture map based on the material data may be aligned and overlaid 114 on top of the image to show material contrast. Thereafter, the perspective view may be displayed 130 to the user via a wireless-connected tablet computer or other computer display. The display may be in real time while the target substrate is still under the scanning electron beam. Interaction with the 3D representation may be provided by way of motion sensitive controls, for example, on a motion-sensitive touch screen of the tablet computer. User input may be received 132 by way of the motion sensitive controls, and the perspective of the stereoscopic view may be adjusted 134 based on the user input. For example, tilt, rotation and zoom inputs may be used to change the perspective displayed.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. A method of real-time three-dimensional electron beam imaging of a substrate surface, the method comprising:
scanning a primary electron beam over the substrate surface causing electrons to be emitted therefrom;
simultaneous detection of emitted electrons using a plurality of at least two off-axis sensors so as to generate a plurality of image data frames, each image data frame being due to electrons emitted from the substrate surface at a different view angle;
automatically processing the plurality of image data frames to generate a three-dimensional representation of the substrate surface, align the three-dimensional representation to design data associated with the substrate surface being imaged, and rectify a surface height map of the three-dimensional representation using layer information in the design data; and
displaying multiple views of the three-dimensional representation.

2. The method of claim 1, wherein the off-axis sensors comprise off-axis detector segments.

3. The method of claim 2, wherein the off-axis detector segments surround a on-axis detector segment.

4. The method of claim 1, wherein the off-axis sensors are positioned in a below-the-lens configuration.

5. The method of claim 1, wherein the off-axis sensors are positioned in a behind-the-lens configuration.

6. (canceled)

7. (canceled)

8. The method of claim 1, further comprising:
overlaying a texture map showing material contrast on the views to be displayed, wherein the texture map is based on material data associated with the substrate surface being imaged.

9. The method of claim 1, further comprising:
generating left and right stereoscopic views to be displayed.

10. The method of claim 1, further comprising:
determining a flyover view path; and
generating a video of the substrate surface based on the flyover view path.

11. The method of claim 1, wherein the views are displayed on a wireless-connected tablet computer.

12. The method of claim 1, further comprising:
receiving user input to change a view being displayed; and
adjusting a view in accordance with the user input.

13. An apparatus configured for real-time three-dimensional electron beam imaging of a substrate surface, the apparatus comprising:
a source for generating a primary electron beam;
scan deflectors configured to deflect the primary electron beam so as to scan the primary electron beam over the substrate surface causing electrons to be emitted from the substrate surface;
a detection system configured for the simultaneous detection of emitted electrons using a plurality of at least two off-axis sensors so as to generate a plurality of image data frames, each image data frame being due to electrons emitted from the substrate surface at a different view angle; and
an image data processing system configured to automatically process the plurality of image data frames to generate multiple views of a three-dimensional representation of the substrate surface, wherein the automatic processing performed by the image processing system includes aligning the three-dimensional representation to design data associated with the substrate surface being imaged and rectifying a surface height map of the three-dimensional representation using layer information in the design data.

14. The apparatus of claim 13, wherein the off-axis sensors comprise off-axis detector segments.

15. The apparatus of claim 14, wherein the off-axis detector segments surround a on-axis detector segment.

16. The apparatus of claim 13, wherein the off-axis sensors are positioned in a below-the-lens configuration.

17. The apparatus of claim 13, wherein the off-axis sensors are positioned in a behind-the-lens configuration.

18. (canceled)

19. (canceled)

20. The apparatus of claim 13, wherein the generation of multiple views performed by the image processing system includes overlaying a texture map showing material contrast on the views to be displayed, wherein the texture map is based on material data associated with the substrate surface being imaged.

21. The apparatus of claim 13, wherein the generation of multiple views performed by the image processing system includes generating left and right stereoscopic views to be displayed.

22. The apparatus of claim 13, wherein the generation of multiple views performed by the image processing system includes determining a flyover view path and generating a video of the substrate surface based on the flyover view path.

23. The apparatus of claim 13, further comprising:
a wireless-connected tablet computer which is configured to display the multiple views.

24. The apparatus of claim 13, wherein the image processing system is further configured to receive user input to change a view being displayed and to adjust a view in accordance with the user input.
